(19) United States
(12) Patent Application Publication
(10) Pub. No.: US 2024/0339855 A1
(43) Pub. Date: Oct. 10, 2024

(54) Method for rapid charging of a rechargeable battery

(71) Applicant: Hilti Aktiengesellschaft, Schaan (LI)

(72) Inventors: Johannes LANDESFEIND, Wielenbach (DE); Philipp BRAUN, Kaufbeuren (DE); Roy DATTATREYA, Winnenden (DE)

(21) Appl. No.: 18/681,387

(22) PCT Filed: Aug. 4, 2022
(86) PCT No.: PCT/EP22/71923

§ 371 Date: Feb. 5, 2024

(30) Foreign Application Priority Data
Aug. 20, 2021 (EP) 21192398.2

(51) Int. Cl. H02J 7/00; B25F 5/02

(52) U.S. Cl. CPC H02J 7/007194; H02J 7/0047; B25F 5/02

(57) ABSTRACT

A method for open-loop and closed-loop control of a rechargeable battery having at least one energy storage cell, at least one temperature sensor for detecting at least one temperature value of the rechargeable battery, a current measuring device, a voltage measuring device and also a rechargeable battery control device having at least one rechargeable battery storage device. The method involves the method steps of setting a first charging current value for charging the rechargeable battery; charging the rechargeable battery with the first charging current value until a first temperature value is reached; setting a second charging current value for charging the rechargeable battery for maintaining the first temperature value for a first predetermined time duration; setting a third charging current value for charging the rechargeable battery after a second predetermined time duration has elapsed; and setting a first voltage value after the second predetermined time duration has elapsed. Rechargeable battery and charger for carrying out the method.

The present invention relates to a method for open-loop and closed-loop control of a rechargeable battery for supplying a power tool with electrical energy, the rechargeable battery containing at least one energy storage cell, at least one temperature sensor, a current measuring device, a voltage measuring device and also a rechargeable battery control device having at least one rechargeable battery storage device.

Furthermore, the present invention relates to a rechargeable battery for carrying out the method.

Moreover, the present invention relates to a charger for carrying out the method.

### BACKGROUND

Rechargeable batteries are often used for supplying various apparatuses or machines with electrical energy. The use of rechargeable batteries for supplying power tools, such as e.g. drills, hammer drills, saws, grinders, screwdrivers or the like, is likewise very widely known. Rechargeable batteries usually have a multiplicity of energy storage cells (also called cells or rechargeable battery cells) for storing or providing the electrical energy. In this case, the technology of the energy storage cells may be based e.g. on Li-ion, Li-polymer, Li-metal, Ni—Cd, Ni-MH or the like.

A charger is normally used for charging the rechargeable battery with electrical energy. For this purpose, the rechargeable battery is releasably connected to the charger, such that a charging current for charging the rechargeable battery can be set.

The charging process of the rechargeable battery may have a long duration, particularly if the energy storage cells of the rechargeable battery are intended to be charged with electrical energy completely or almost completely. Time-intensive charging of a rechargeable battery may pose a problem if for example only a single rechargeable battery is available as energy supply for a power tool and work using the power tool has to be interrupted during the charging process.

### SUMMARY OF THE INVENTION

It is an object of the present invention to solve the abovementioned problem and to provide a method for open-loop and closed-loop control of a rechargeable battery which makes it possible to ensure that a rechargeable battery is charged as rapidly as possible. Furthermore, it is also an object to provide a rechargeable battery and also a charger for carrying out the method which make it possible to ensure that a rechargeable battery is charged as rapidly as possible.

The present invention provides a method for open-loop and closed-loop control of a rechargeable battery for supplying a power tool with electrical energy, the rechargeable battery containing at least one energy storage cell, at least one temperature sensor, a current measuring device, a voltage measuring device and also a rechargeable battery control device having at least one rechargeable battery storage device.

According to the invention, the method comprises the method steps of:
setting a first charging current value for charging the rechargeable battery;
charging the rechargeable battery with the first charging current value until a first temperature value is reached;
setting a second charging current value for charging the rechargeable battery for maintaining the first temperature value for a first predetermined time duration;
setting a third charging current value for charging the rechargeable battery after a second predetermined time duration has elapsed; and
setting a first voltage value after the second predetermined time duration has elapsed.

In this case, the first temperature value amounts to almost the maximum possible temperature value before the rechargeable battery control device interrupts further charging of the rechargeable battery owing to overheating. The charging current intensity may also be referred to as charging current or charging current value.

According to one advantageous embodiment of the present invention, it may be possible for the energy storage cells to have the lowest internal resistance at the first temperature value. As a result, the energy storage cells can be charged with electrical energy most rapidly.

According to one advantageous embodiment of the present invention, it may be possible for the first charging current value to correspond to a value between 16 and 20 A, in particular 18 A.

According to one advantageous embodiment of the present invention, it may be possible for the second charging current value to correspond to a value between 10 and 14 A, in particular 12 A.

According to one advantageous embodiment of the present invention, the second charging current value is two thirds (i.e. ⅔) of the first charging current value. According to an alternative embodiment of the present invention, the second charging current value can also be only half (i.e. 50%) of the first charging current value. Furthermore, the second charging current value can also be between 20 and 70% of the first charging current value. The second charging current value is however always less than the first charging current value.

According to one advantageous embodiment of the present invention, it may be possible for the first temperature value to correspond to between 55° C. and 65° C., in particular 60° C.

Rechargeable batteries for supplying a power tool typically contain lithium-ion cells (Li-ion), which are charged with electrical energy by conventional chargers generally in a so-called CCCV method (Constant Current Constant Voltage). In this case, charging electronics of the charger generate a constant charging current through the rechargeable battery (Constant Current-CC), with the result that the rechargeable battery voltage rises. As soon as a maximum rechargeable battery voltage is reached, it is kept constant by the charging electronics (Constant Voltage—CV) and the charging current is correspondingly reduced. Once a predefined minimum value of the charging current has been reached, the charging electronics end the charging process and the rechargeable battery cells are fully charged. The transition from the CC phase to the CV phase typically takes place at a state of charge (i.e. capacity) of approximately 80%.

The rechargeable battery voltage of the rechargeable battery is generally a multiple of the voltage of a single energy storage cell or rechargeable battery cell and results from the parallel or serial interconnection of the rechargeable battery cells. In the case of Li-ion rechargeable battery cells having a cell voltage of 3.6 V, exemplary rechargeable battery voltages of 3.6 V, 7.2 V, 10.8 V, 14.4 V, 18 V, 36 V, etc. thus result. Preferably, the rechargeable battery cell is embodied as an at least substantially cylindrical round cell, the terminals of the rechargeable battery cells being arranged at ends of the cylinder shape. The electrical interface comprises in particular at least two electrical contact elements configured for transferring energy.

Alternatively, however, the electrical interface can also have a secondary charging coil element for inductive charging.

According to a further alternative embodiment, the respective rechargeable battery cell can also in the form of a so-called pouch cell, i.e. an energy storage cell having a relatively soft outer shell. In this case, the pouch cell may also be referred to as a pouch bag cell or coffee bag cell.

In one particular embodiment of the invention, the charging process is carried out by means of the CCCV method, wherein the remaining capacity is determined by ascertaining the first charging value before the CC phase and the further charging values during the CC phase and the CV phase. Consequently, before the CC phase the open-circuit voltage is measured and afterward so-called “Coulomb Counting” is carried out, which detects the number of electrons for the purpose of determining the charge in the rechargeable battery.

The remaining capacity, the remaining performance and/or the state of health of the rechargeable battery can particularly advantageously be output on an external display unit.

In this case, both a display (LCD, OLED, ePaper or the like) and an LED display of the rechargeable battery, of the charger or alternatively and/or supplementarily a smartphone, tablet, PC or the like can be used as the display unit.

The communication between the rechargeable battery and the display units mentioned takes place via a corresponding communication interface. In this case, a proprietary BUS (Binary Unit System) can be used, such as a transmission by way of standard protocols by cable or radio.

### BRIEF DESCRIPTION OF THE DRAWINGS

Further advantages will become apparent from the following description of the figures. Various exemplary embodiments of the present invention are illustrated in the figures. The figures, the description and the claims contain numerous features in combination. A person skilled in the art will expediently also consider the features individually and combine them to form useful further combinations.

In the figures, identical components and components of identical type are designated by the same reference signs. In the figures:

FIG. 1 shows a sectional view through a rechargeable battery connected to a charger;

FIG. 2 shows a sectional view through the rechargeable battery connected to a power tool; and

FIG. 3 shows a schematic diagram for representing the current, voltage and temperature profiles during a charging process of the rechargeable battery.

### DETAILED DESCRIPTION

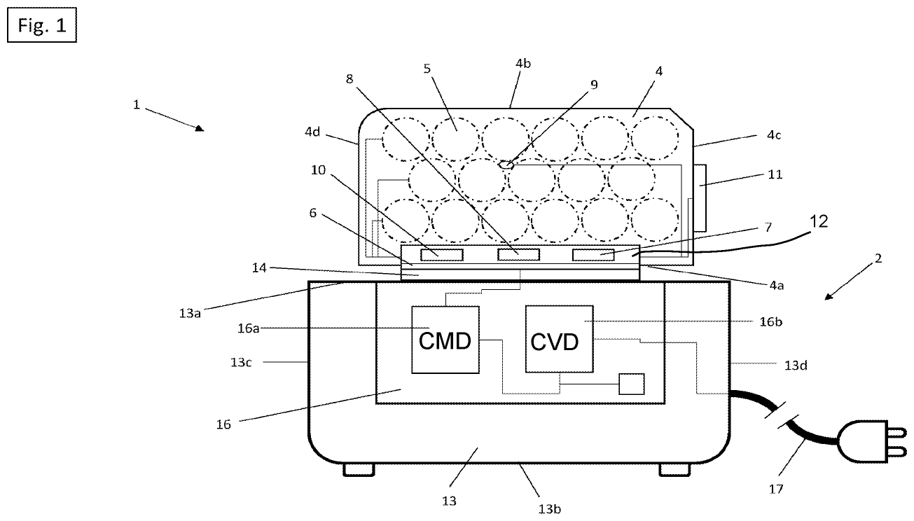

FIG. 1 shows a rechargeable battery 1 releasably connected to a charger 2.

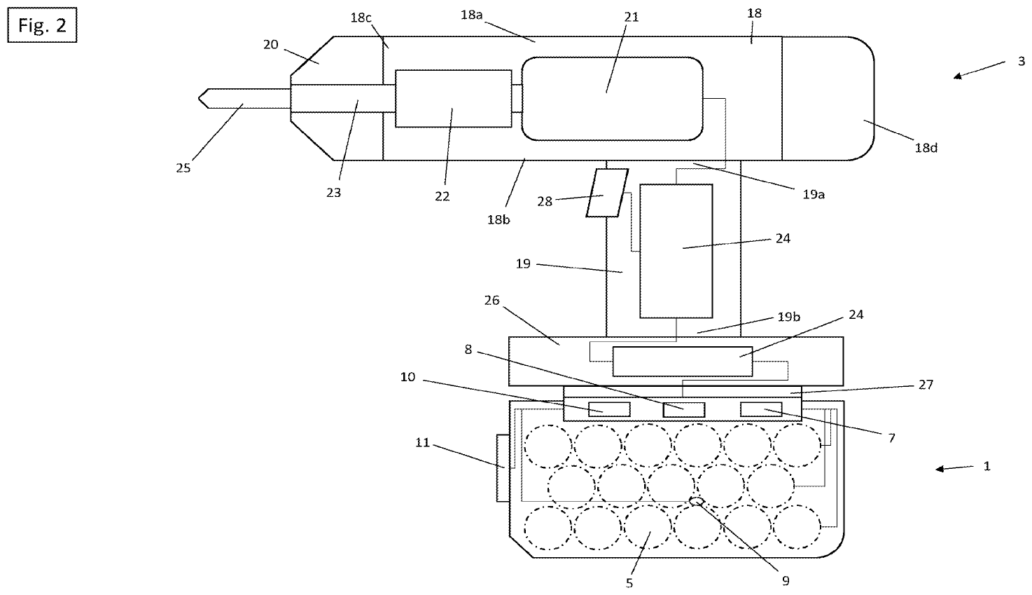

The rechargeable battery 1 can the used as an energy supply for a power tool 3. The power tool 3 is illustrated in the form of a rechargeable battery-operated screwdriver in FIG. 2.

The rechargeable battery 1 substantially contains a rechargeable battery housing 4, a number of energy storage cells 5, a rechargeable battery interface 6, a current measuring device 7, a voltage measuring device 8, a temperature sensor 9, a rechargeable battery storage device 10, a display and input device 11 and also a rechargeable battery control device 12.

The rechargeable battery housing 4 contains a top side 4a, an underside 4b, a left side wall, a right side wall, a front side 4c and a rear side. Only the top side 4a, the underside 4b, the front side 4c and the rear side 4d are shown in FIG. 1.

The rechargeable battery interface 6 is positioned at the top side 4a of the rechargeable battery housing 4 and serves for releasably connecting the rechargeable battery 3 to the charger 2 or a power tool 3. For this purpose, the rechargeable battery interface 6 contains a mechanical coupling device, an electrical connection device and also a communication connection. Neither the mechanical coupling device nor the electrical connection device nor the communication connection of the rechargeable battery interface 6 is shown in the figures.

The mechanical coupling device, the electrical connection device and the communication connection of the rechargeable battery interface 6 is not shown in the figures.

By means of the mechanical coupling device, the rechargeable battery 1 can be connected either to the charger 2 or to a power tool 3 in a form- and force-fitting manner. By means of the electrical connection device, electrical energy can pass from the charger 2 to the rechargeable battery 1 when the rechargeable battery 1 is connected to the charger 2. Likewise, electrical energy can pass from the rechargeable battery 1 to a power tool 3 when the rechargeable battery 1 is connected to the power tool 3. The communication connection serves to enable the exchange of information and data in the form of signals between the rechargeable battery 1 and the charger 2 or between the rechargeable battery 1 and the power tool 3. The information and data can include, inter alia, charging or discharging parameters, temperature values, state of charge (SOC), the state of health (SOH), (remaining) capacity, voltage, current intensity or the like.

The rechargeable battery control device 12 is positioned substantially in proximity to the top side of the rechargeable battery housing 4 and serves for open-loop and closed-loop control of the various functions of the rechargeable battery 1.

The energy storage cells 5 are positioned in three rows in the interior of the rechargeable battery housing 4, such that the temperature sensor 9 is positioned between the second and third rows of the energy storage cells 5. The temperature sensor 9 serves for detecting the temperature in the interior of the rechargeable battery 1 at one of the centrally positioned energy storage cells 5. The temperature sensor 9 is connected to the rechargeable battery control device 12 via a line. Since the energy storage cells 5 in the interior or in the center of the rechargeable battery 1 usually have the highest temperatures during the charging or discharging process, a temperature sensor 9 that detects the temperature at said centrally positioned energy storage cell 5 can establish the highest temperature and thus extremely rapidly a critically high temperature for the rechargeable battery 1.

Furthermore, the current measuring device 7, the voltage measuring device 8 and the rechargeable battery storage device 10 are contained within the rechargeable battery control device 12.

The current measuring device 7 serves for detecting or measuring the current intensity at the individual energy storage cells 5. As indicated in FIG. 1, the current measuring device 7 is therefore connected to each individual energy storage cell 5. Detecting or measuring the current intensity at the individual energy storage cell 5 makes it possible to ascertain the current intensity for the entire rechargeable battery 1.

The voltage measuring device 8 serves for detecting or measuring the voltage at the individual energy storage cells 5. As indicated in FIG. 1, the voltage measuring device 8 is therefore connected to each individual energy storage cell 5. Detecting or measuring the voltage at the individual energy storage cell 5 makes it possible to ascertain the voltage for the entire rechargeable battery 1.

The storage device 10 serves for storing and providing a wide variety of information and data, such as e.g. lookup tables for the various charging or discharging parameters of the rechargeable battery 1. These parameters include, inter alia, temperature profiles or threshold values for voltages or current intensities.

The display and input device 11, which may also be referred to as a human-machine interface (HMI), is positioned at the front side of the rechargeable battery housing 4. As indicated in FIG. 1, the display and input device 11 is connected to the rechargeable battery control device 12, such that various data and items of information are discernible on a display portion of the display and input device 11. In particular, it is possible to display the state of charge or the capacity of the rechargeable battery 1 on the display portion.

On an input portion of the display and input device 11, it is possible for a user to select and adjust various operating states (alternatively called operating modes or modes) for the rechargeable battery 1. The various operating states include specific states of charge or discharge, for example. In a first selectable operating state, a CCCV charging method is set for the rechargeable battery 1. In a second selectable operating state, a rapid charging method is set for the rechargeable battery 1, in which method a relatively short charging time can be attained with relatively high charging currents. In a third selectable operating state, a slow and gentle charging method is set for the rechargeable battery 1, in which method a relatively long charging time but also charging that is gentle (i.e. not very burdensome) for the energy storage cells 5 can be attained with relatively low charging currents.

The charger 2 contains a charger housing 13, a charger interface 14, a charger storage device 15 and also a charger control device 16.

The charger control device 16 contains a current measuring device 16a and a voltage measuring device 16b.

The charger housing 13 contains a top side 13a, and underside 13b, a left side wall, a right side wall, a front side 13c and a rear side 13d. Only the top side 13a, the underside 13b, the front side 13c and the rear side 13d are shown in FIG. 1.

The charger interface 14 is positioned at the top side 13a of the charger housing 13 and serves for releasably connecting the charger 2 to the rechargeable battery 1. For this purpose, the charger interface 14 contains a mechanical coupling device, an electrical connection device and also a communication connection.

The mechanical coupling device, the electrical connection device and the communication connection of the charger 2 are embodied in a manner corresponding to the mechanical coupling device, the electrical connection device and the communication connection of the rechargeable battery 1, such that the components of the charger interface 14 and of the rechargeable battery interface 6 can be correspondingly connected to one another.

Furthermore, the charger 2 has a power connection cable 17, which projects from the charger housing 14 and is connected to the charger control device 16. The power connection cable 17 serves for releasably connecting the charger 2 to a grid power source (power outlet).

FIG. 2 shows the rechargeable battery 1 releasably connected to the power tool 3. As already described above, the power tool 3 is embodied as a rechargeable battery-operated screwdriver in FIG. 2. Alternatively, the power tool 3 can also be embodied as a hammer drill, a drill, a saw, a grinder or the like. The power tool 3 embodied as a rechargeable battery-operated screwdriver substantially contains a housing 18, a handle 19 and also a tool fitting 20.

The housing 18 of the power tool 2 in turn contains a top side 18a, an underside 18b, a front end 18c and a back end 18d. Substantially a drive 21, a transmission 22, an output shaft 23 and a control apparatus 24 are contained in the interior of the housing 18. The drive 21 is embodied as an electric motor and serves for generating a torque. As shown in FIG. 2, the drive 21, the transmission 22, the output shaft 23 and the tool fitting 20 are arranged relative to one another such that a torque generated by the drive 21 can be transmitted to the tool fitting 20 via the transmission 22 and the output shaft 23.

The tool fitting 20 serving for receiving and holding a tool 25 is positioned at the front end 18c. The tool 25 is a screwdriver bit.

The handle 19 allows the power tool 3 to be held and guided by a user (not shown). In this case, the handle 19 contains an upper end 19a and a lower end 19b. The handle 19 is secured by the upper end 19a to the underside 19b of the housing 19 of the power tool 2. A base apparatus 26 having a power tool interface 27 is positioned at the lower end 19b of the handle 19.

Furthermore, the handle 19 has an activation switch 28 connected to the control device 24. The activation switch 28 enables a user to put the power tool 2 into an activation state or a deactivation state depending on the positioning of the activation switch 28. In an activation state, the drive 21 generates a torque.

The power tool interface 27 serves for releasably connecting the power tool 3 to the rechargeable battery 1. For this purpose, the power tool interface 27 contains a mechanical coupling device, an electrical connection device and also a communication connection.

The mechanical coupling device, the electrical connection device and the communication connection of the power tool 3 are embodied in a manner corresponding to the mechanical coupling device, the electrical connection device and the communication connection of the rechargeable battery 1, such that the components of the power tool 3 and of the rechargeable battery interface 6 can be correspondingly connected to one another.

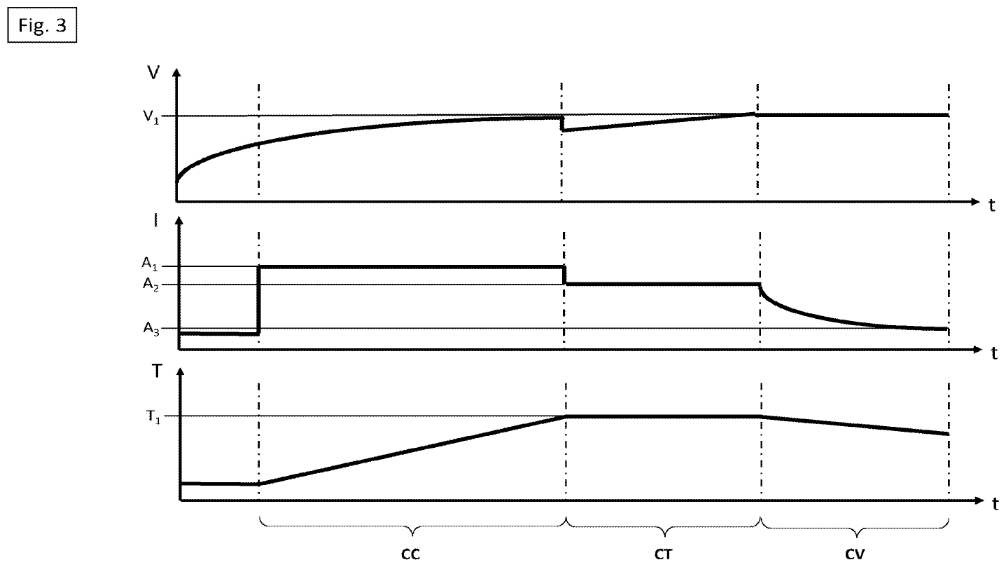

FIG. 3 shows graphical representations of a temporal profile of the voltage value (V−t), of the (charging) current value (I−t) and of the temperature value (T−t) during a charging process of the rechargeable battery. In this case, the profile of the voltage value and of the current value substantially corresponds to the CCCV method.

In order to carry out the method, firstly the rechargeable battery 1 is connected to the charger 2 such that the corresponding mechanical coupling devices, the electrical connection devices and the communication connections of the rechargeable battery 1 and of the charger 2 are coupled to one another. By means of the coupling of the communication connections of the rechargeable battery 1 and of the charger 2, data and items of information regarding the charging specification or charging parameters, in particular threshold values for a maximum charging current or a maximum charging voltage, are exchanged between the rechargeable battery 1 and the charger 2.

As a result of the connection of the electrical connection devices of the rechargeable battery 1 and of the charger 2, electrical energy is conducted from the charger 2 to the rechargeable battery 1, a value for a charging current intensity A₁ being set at the charger 2. The value for the charging current intensity A₁ remains substantially unchanged for the phase CC (constant current-constant current intensity). In the present exemplary embodiment, the value for the charging current intensity A₁ is 18 A (=amperes). The value for the charging current intensity A₁ remains at 18 A until the end of the phase CC and until the beginning of the phase CT and also until a specific temperature value for the rechargeable battery 1 is reached. As already described above, the temperature of the rechargeable battery 1 is detected with the aid of the temperature sensor 9. In the present exemplary embodiment, the temperature T₁ is substantially 60° C., cf. FIG. 3. Starting from the phase CT (constant temperature), the temperature of the rechargeable battery 1 is substantially maintained at 60° C. In order to regulate the temperature value or control it by closed-loop control, the charging current intensity A₁ is increased or reduced by a certain amount. The higher the value for the charging current intensity A₁, the hotter the rechargeable battery becomes or the higher the temperature value rises. Conversely, the temperature of the rechargeable battery can be correspondingly reduced by decreasing the value for the charging current intensity A₁. The phase CT corresponds to a predeterminable time duration. In the present exemplary embodiment, this time duration is between 200 and 300 seconds. Alternatively, this time duration can also be longer or shorter. It should be noted that within the time duration CT when the internal resistance of the energy storage cells is the lowest, the rechargeable battery 1 can be charged with electrical energy most rapidly. It is therefore advantageous to extend the time duration CT as long as possible in order to charge the rechargeable battery as rapidly as possible and without possibly damaging components of the rechargeable battery 1. Furthermore, starting from the phase CT, the value for the charging current intensity A₁ is reduced from 18 A to a value for the charging current intensity A₂ of 12 A. As evident in the graph in FIG. 3, the charging current intensity is reduced from 18 A to 12 A in a negatively delayed manner. It should be noted that the value of the charging current intensity A₂ is two thirds (i.e. ⅔) of the value of the charging current intensity A₁.

At the end of the phase CT and upon the beginning of the phase CV (constant voltage), the voltage for charging the rechargeable battery is set to a constant value. In the present exemplary embodiment, the voltage value in the phase CV is substantially 4.2 V. Furthermore, at the beginning of the phase CV, the value for the charging current intensity A₁ is reduced continuously from 12 A to a value for a charging current intensity A₃ of 5 A. Furthermore, the temperature decreases from a maximum temperature value T₁ of 60° C. to a value of 55° C.

In this case, the value for the charging current intensity A₁, A₂ is set by means of a corresponding signal from the rechargeable battery 1 to the charger 2 via the communication connections. The charging voltage V₁ is set and controlled by means of the voltage measuring device 8 of the rechargeable battery 1. Alternatively, the charging voltage can be detected by means of the voltage measuring device 16b of the charger 2. The detected value for the charging voltage is stored in the rechargeable battery storage device 10. Alternatively, the detected value for the charging voltage can be stored in the charger storage device 15.

The above method according to the invention describes a charging process of the rechargeable battery 1 at the charger 2. However, the method according to the invention can also be used for a discharging process of the rechargeable battery 1 as energy supply at a power tool 3.

The method during a discharging process of the rechargeable battery 1 is almost identical to the charging process of the rechargeable battery 1. In contrast to the method during the charging process of the rechargeable battery 1, during the discharging process electrical energy passes from the rechargeable battery 1 to the power tool 3.

### LIST OF REFERENCE SIGNS

1 Rechargeable battery
2 Charger
3 Power tool
4 Rechargeable battery housing
4a Top side of the rechargeable battery housing
4b Underside of the rechargeable battery housing
4c Front side of the rechargeable battery housing
4d Rear side 4d of the rechargeable battery housing
5 Energy storage cell
6 Rechargeable-battery interface
7 Current measuring device of the rechargeable battery
8 Voltage measuring device of the rechargeable battery
9 Temperature sensor of the rechargeable battery
10 Rechargeable battery storage device
11 Display and input device
12 Rechargeable battery control device
13 Charger housing
13a Top side of the charger housing
13b Underside of the charger housing
13c Front side of the charger housing
13d Rear side of the charger housing
14 Charger interface
15 Charger storage device
16 Charger control device
16a Current measuring device
16b Voltage measuring device
17 Power connection cable
18 Housing of the power tool
18a Top side of the power tool housing
18b Underside of the power tool housing
18c Front end of the power tool housing
18d Back end of the power tool housing
19 Handle
20 Tool fitting
21 Drive
22 Transmission
23 Output shaft
24 Control apparatus
25 Tool
26 Base apparatus
27 Power tool interface
28 Activation switch

What is claimed is:

1-7. (canceled)

8. A method for open-loop and closed-loop control of a rechargeable battery for supplying a power tool with electrical energy, the rechargeable battery containing at least one energy storage cell, at least one temperature sensor for detecting at least one temperature value of the rechargeable battery, a current measurer, a voltage measurer and a rechargeable battery controller having at least one rechargeable battery storage, the method comprising the steps of:
setting a first charging current value for charging the rechargeable battery;
charging the rechargeable battery with the first charging current value until a first temperature value is reached;
setting a second charging current value for charging the rechargeable battery for maintaining the first temperature value for a first predetermined time duration;
setting a third charging current value for charging the rechargeable battery after a second predetermined time duration has elapsed; and
setting a first voltage value after the second predetermined time duration has elapsed.

9. The method as recited in claim 8 wherein the energy storage cells have a lowest internal resistance at the first temperature value.

10. The method as recited in claim 8 wherein the first charging current value corresponds to a value of between 16 and 20 A.

11. The method as recited in claim 10 wherein the first charging current value is 18 A.

12. The method as recited in claim 8 wherein the second charging current value corresponds to a value of between 10 and 14 A.

13. The method as recited in claim 12 wherein the second charging current value is 12 A.

14. The method as recited in claim 8 wherein the first temperature value corresponds to between 55° C. and 65° C., in particular 60° C.

15. The method as recited in claim 14 wherein the first temperature value is 60° C.

16. A rechargeable battery for carrying out the method as recited in claim 8, the rechargeable battery comprising:
the at least one energy storage cell, the at least one temperature sensor for detecting at least one temperature value of the rechargeable battery, the current measurer, the voltage measurer and the rechargeable battery controller having the at least one rechargeable battery storage.

17. A charger for carrying out the method as recited in claim 8, the charger comprising a charger controller having at least one charger storage.
